(19) United States
(12) Patent Application Publication
(10) Pub. No.: US 2024/0351635 A1
(43) Pub. Date: Oct. 24, 2024

(54) VEHICLE CONTROL DEVICE

(71) Applicant: Toyota Jidosha Kabushiki Kaisha, Toyota-shi (JP)

(72) Inventors: Kota KIMURA, Anjo-shi (JP); Yu SAKAI, Nagakute-shi (JP)

(73) Assignee: Toyota Jidosha Kabushiki Kaisha, Toyota-shi (JP)

(21) Appl. No.: 18/420,103

(22) Filed: Jan. 23, 2024

(30) Foreign Application Priority Data
Apr. 21, 2023 (JP) 2023-069886

(51) Int. Cl. B62D 15/02; G07C 5/02

(52) U.S. Cl. CPC B62D 15/0255; G07C 5/02

(57) ABSTRACT

A vehicle control device does not execute the lane change assist control when a request operation for requesting the start of the lane change assist control is performed and a permission condition that the host vehicle traveling road is a road on which lane change using the lane change assist control is permitted is not satisfied. In a case where the request operation is performed even though the permission condition is not satisfied, the vehicle control device gives the non-execution notification for notifying the operator of the information regarding the non-execution of the lane change assist control, and does not give the non-execution notification when the misrecognition condition is not satisfied, when the request operation is performed, and when the lane change assist control is not satisfied, the vehicle control device does not give the non-execution notification.

### CROSS-REFERENCE TO RELATED APPLICATION

This application claims priority to Japanese Patent Application No. 2023-069886 filed on Apr. 21, 2023, incorporated herein by reference in its entirety.

### BACKGROUND

### 1. Technical Field

The present disclosure relates to vehicle control devices.

### 2. Description of Related Art

A vehicle control device that performs a lane change assist control for assisting in lane change of a vehicle is known in the art. A vehicle control device is also known in the art that, when execution of a lane change assist control is not permitted in response to an operation (request operation) requesting execution of the lane change assist control by an operator of a vehicle, does not execute the lane change assist control and notifies the operator of the vehicle of information about not executing the lane change assist control (e.g., Japanese Unexamined Patent Application Publication No. 2017-97495 (JP 2017-97495 A)).

### SUMMARY

There is a situation where the operator of the vehicle does not expect execution of the lane change assist control even when he or she performs the request operation. For example, such a situation may occur when the operator of the vehicle is aware that execution of the lane change assist control will not be permitted and the operation performed by the operator of the vehicle to change lanes is the same as the request operation. If a notification notifying the operator of the vehicle of the information about nor executing the lane change assist control (non-execution notification) is given in this situation, it will annoy the operator of the vehicle.

It is an object of the present disclosure to provide a vehicle control device that executes a lane change assist control and that reduces the possibility of an operator of a vehicle being annoyed by a non-execution notification being given in a situation where such a non-execution notification is not necessary.

A vehicle control device according to the present disclosure executes a lane change assist control for assisting in lane change of a vehicle.

The vehicle control device according to the present disclosure is configured to execute the lane change assist control when a permission condition is satisfied at a time a request operation requesting to start the lane change assist control is performed by an operator of the vehicle, the permission condition being a condition that a road on which the vehicle is traveling is a road where the lane change of the vehicle using the lane change assist control is permitted, and not execute the lane change assist control when the permission condition is not satisfied at the time the request operation is performed by the operator.

The vehicle control device according to the present disclosure is configured to give a non-execution notification when a misrecognition condition is satisfied in a case where the request operation is performed by the operator although the permission condition is not satisfied, the misrecognition condition being a condition that the operator misrecognizes the road on which the vehicle is traveling as the road where the lane change of the vehicle using the lane change assist control is permitted, and the non-execution notification being a notification for notifying the operator of information about not executing the lane change assist control, and not give the non-execution notification when the misrecognition condition is not satisfied in the case where the request operation is performed by the operator although the permission condition is not satisfied.

According to the present disclosure, the non-execution notification is not given when the operator of the vehicle does not misrecognize that the lane change of the vehicle using the lane change assist control can be performed, and the non-execution notification is given only when the operator of the vehicle misrecognizes that the lane change of the vehicle can be performed. It is therefore possible to reduce the possibility of annoying the operator by the non-execution notification being given in a situation where the non-execution notification is not necessary.

The vehicle control device according to the present disclosure may be configured to determine that the misrecognition condition is satisfied when the vehicle is traveling on a trunk road.

When the vehicle is traveling on a trunk road, there is a possibility that the operator of the vehicle may misrecognize that the lane change of the vehicle using the lane change assist control can be performed. According to the present disclosure, it is determined that the misrecognition condition is satisfied in such a situation. Accordingly, the non-execution notification is given when the request operation requesting to start the lane change assist control is performed by the operator of the vehicle. It is therefore possible to give the non-execution notification in a situation appropriate to give the non-execution notification.

In the vehicle control device according to the present disclosure, the vehicle control device may be configured to determine that the misrecognition condition is satisfied when equipment of a same type as equipment that is mounted on a road where the permission condition is satisfied and that does not satisfy the permission condition is mounted on the road on which the vehicle is traveling.

When equipment of the same type as the equipment mounted on the road where the permission condition is satisfied is mounted on the road on which the vehicle is traveling, there is a possibility that the operator of the vehicle may misrecognize that the lane change of the vehicle using the lane change assist control can be performed, even when this equipment is not equipment that satisfies the permission condition. According to the present disclosure, it is determined that the misrecognition condition is satisfied in such a situation. Accordingly, the non-execution notification is given when the request operation requesting to start the lane change assist control is performed by the operator of the vehicle. It is therefore possible to give the non-execution notification in a situation appropriate to give the non-execution notification.

The vehicle control device according to the present disclosure may be configured to determine that the misrecognition condition is satisfied when the vehicle is traveling on a road an operator of another vehicle different from the vehicle misrecognized as a road where a lane change of the another vehicle using the lane change assist control is permitted.

When the vehicle is traveling on the road the operator of the another vehicle misrecognized as the road where the lane change of the another vehicle using the lane change assist control is permitted, there is a high possibility that the operator of the vehicle misrecognizes the road on which the vehicle of the operator is traveling as the road on which the lane change of the vehicle using the lane change assist control is permitted. According to the present disclosure, it is determined that the misrecognition condition is satisfied in such a situation. Accordingly, the non-execution notification is given when the request operation requesting to start the lane change assist control is performed by the operator of the vehicle. It is therefore possible to give the non-execution notification in a situation appropriate to give the non-execution notification.

The vehicle control device according to the present disclosure may be configured to determine that the misrecognition condition is satisfied when a travel speed of the vehicle is equal to or higher than a predetermined speed threshold.

When the vehicle is traveling at a high speed, there is a possibility that the operator of the vehicle may misrecognize that the lane change of the vehicle using the lane change assist control can be performed. According to the present disclosure, it is determined that the misrecognition condition is satisfied in such a situation. Accordingly, the non-execution notification is given when the request operation requesting to start the lane change assist control is performed by the operator of the vehicle. It is therefore possible to give the non-execution notification in a situation appropriate to give the non-execution notification.

The components of the present disclosure are not limited to the embodiment of the present disclosure described later with reference to the drawings. Other objects, other features, and accompanying advantages of the present disclosure will be readily understood from the description of the embodiment of the present disclosure.

The present disclosure is applicable to any of a vehicle that can be driven by manual driving operation and autonomous driving control, a vehicle that is driven only by manual driving operation, and a vehicle that is driven only by autonomous driving control. The manual driving operation is a driving operation that is performed by the operator to cause the vehicle to travel. The autonomous driving control is a control in which a control device such as an electronic control unit (ECU) automatically causes the vehicle to travel without the operator performing a driving operation for causing the vehicle to travel.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a vehicle control device according to an embodiment of the present disclosure;

FIG. 2 is a view showing a scene in which a lane change of a vehicle is performed by a vehicle control device according to an embodiment of the present disclosure; and

FIG. 3 is a flowchart illustrating a routine executed by the vehicle control device according to the embodiment of the present disclosure.

### DETAILED DESCRIPTION OF EMBODIMENTS

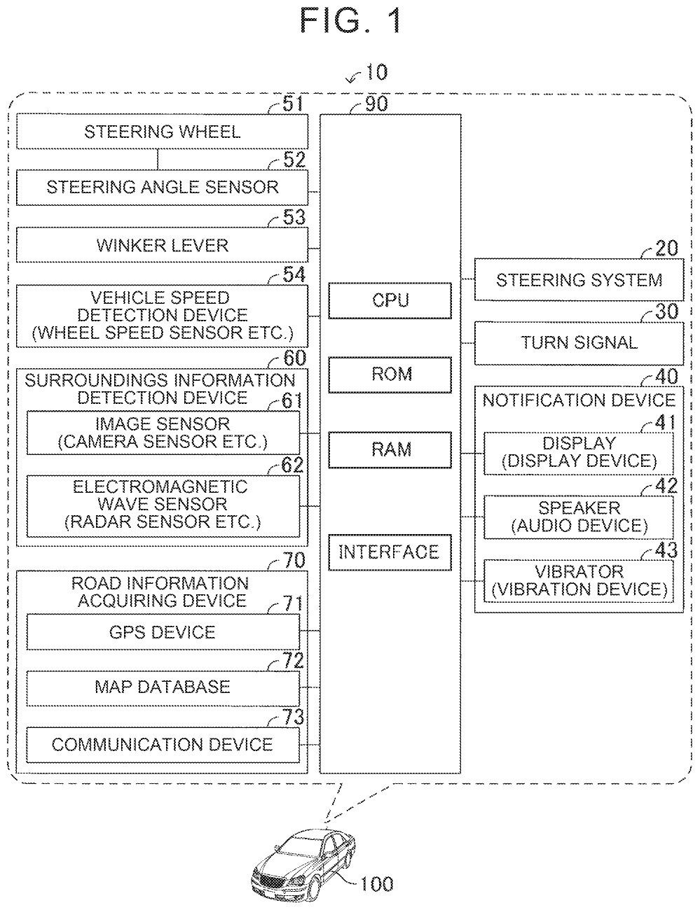

Hereinafter, a vehicle control device according to an embodiment of the present disclosure will be described with reference to the drawings. FIG. 1 shows a vehicle control device 10. The vehicle control device 10 is mounted on the host vehicle 100. Hereinafter, the vehicle control device 10 will be described by taking as an example a case where an operator of the host vehicle 100 is a person who rides on the host vehicle 100 and drives the host vehicle 100 (that is, a driver of the host vehicle 100).

However, the operator of the host vehicle 100 may be a person who drives the host vehicle 100 remotely without getting on the host vehicle 100 (that is, a remote operator of the host vehicle 100). When the operator of the host vehicle 100 is a remote operator, the vehicle control device 10 is mounted on the host vehicle 100 and a remote control facility installed outside the host vehicle 100 for remotely driving the host vehicle 100, and the functions of the vehicle control device 10 described below are shared by the vehicle control device 10 mounted on the host vehicle 100 and the vehicle control device 10 mounted on the remote control facility.

As illustrated in FIG. 1, the vehicle control device 10 includes an electronic control unit (ECU) 90 as a control device. ECU 90 includes a microcomputer as a main part. The microcomputer includes a storage medium such as a CPU, ROM, RAM and a non-volatile memory, an interface, and the like. CPU implements various functions by executing instructions, programs, or routines stored in a storage medium. In particular, in the present example, the vehicle control device 10 stores, in a storage medium, a program for realizing various kinds of control executed by the vehicle control device 10.

In the present embodiment, the vehicle control device 10 includes only one ECU 90, but may include a plurality of ECU, and may be configured to share the functions of the vehicle control device 10 described below by the respective ECU.

Further, the vehicle control device 10 may be configured to be able to update a program stored in the storage medium by wireless communication (for example, Internet communication) with an external device.

The host vehicle 100 is equipped with a steering device 20, a direction indicator 30, a notification device 40, a steering wheel 51, a steering angle sensor 52, a winker lever 53, a vehicle speed detection device 54, a peripheral information detection device 60, and a road information acquiring device 70.

The steering device 20 is a device such as a power steering device that applies a steering force to the vehicle 100 to steer the vehicle 100. The steering device 20 is electrically connected to ECU 90. The vehicle control device 10 can apply a steering force to the host vehicle 100 and steer the host vehicle 100 by controlling the operation of the steering device 20.

The direction indicator 30 is a device such as a winker that blinks to notify a person outside the host vehicle 100 of the turning direction of the host vehicle 100. The indicator 30 is electrically connected to ECU 90. The vehicle control device 10 can control the operation of the direction indicator 30.

The notification device 40 is a device that performs notification for providing various kinds of information to the driver of the host vehicle 100. In this example, the notification device 40 includes a display 41 as a display device, a speaker 42 as an acoustic device, and a vibrator 43 as a vibration device. The display 41, the speaker 42, and the vibrator 43 are electrically connected to ECU 90. The vehicle control device 10 can display various images on the display 41, can output various sounds from the speaker 42, and can vibrate the vibrator 43. The display 41 is mounted on the vehicle 100 so that the driver can visually recognize an image displayed on the display 41. The speaker 42 is mounted on the vehicle 100 so that the driver can hear the sound output from the speaker 42. The vibrator 43 is mounted on the steering wheel 51.

The steering wheel 51 is a device operated by a driver and is connected to the steering wheel of the host vehicle 100 via a steering shaft. The steering angle sensor 52 is a sensor that detects a rotation angle of the steering shaft (that is, a rotation angle of the steering wheel 51). The angle of rotation of the steering shaft is the angle of rotation of the steering shaft from the neutral position of the steering shaft, and thus the angle of rotation of the steering wheel 51 is the angle of rotation of the steering wheel 51 from the neutral position of the steering wheel 51. The steering angle sensor 52 is electrically connected to ECU 90. The vehicle control device 10 acquires the rotation angle of the steering shaft as the steering angle θ by the steering angle sensor 52. When the steering wheel 51 is operated by the driver, the vehicle control device 10 controls the operation of the steering device 20 so that the steering force corresponding to the acquired steering angle θ is given to the vehicle 100. Note that the vehicle control device 10 autonomously controls the operation of the steering device 20 to apply a steering force to the vehicle 100 when executing lane change assist control to be described later.

The winker lever 53 is a device operated by a driver. The winker lever 53 is electrically connected to ECU 90. When the winker lever 53 is operated by the driver, the vehicle control device 10 controls the operation of the direction indicator 30 in accordance with the operation.

The vehicle speed detection device 54 is a device that detects the traveling speed of the host vehicle 100. The vehicle speed detection device 54 is electrically connected to ECU 90. The vehicle control device 10 acquires the traveling speed of the host vehicle 100 as the host vehicle speed V by the vehicle speed detection device 54.

The peripheral information detection device 60 is a device that acquires information on a state around the vehicle 100. In the present example, the peripheral information detection device 60 includes an image sensor 61 and an electromagnetic wave sensor 62.

The image sensor 61 is a sensor that captures an image of the surroundings of the host vehicle 100. The image sensor 61 is, for example, a camera sensor. The image sensor 61 is electrically connected to ECU 90. The vehicle control device 10 acquires the image data around the vehicle 100 as the surroundings detection information IS by the image sensor 61.

The electromagnetic wave sensor 62 is a sensor that transmits an electromagnetic wave around the vehicle 100 and receives the electromagnetic wave reflected by the object around the vehicle 100. The electromagnetic wave sensor 62 is, for example, a millimeter wave radar. The electromagnetic wave sensor 62 is electrically connected to ECU 90. The vehicle control device 10 acquires, by the electromagnetic wave sensor 62, data (target data) related to an object in the vicinity of the host vehicle 100 as the surroundings detection information IS.

The road information acquiring device 70 is a device that acquires information related to a road (vehicle traveling road RDego) on which the host vehicle 100 is traveling. In the present embodiment, the roadway-information acquiring device 70 includes a GPS device 71, a map database 72, and a communication device 73.

The GPS device 71 is a device that receives so-called GPS signals. GPS device 71 is electrically connected to ECU 90. The vehicle control device 10 acquires the present position of the host vehicle 100 based on GPS signal acquired via GPS device 71.

The map database 72 is a device that stores map information. The map database 72 is electrically connected to ECU 90. The vehicle control device 10 acquires information on the vehicle traveling road RDego from the map database 72 as the road information IR based on the present position of the vehicle 100 acquired as described above. Note that the vehicle control device 10 may be configured to acquire map data on a so-called cloud as a road-information IR instead of the map database 72.

The communication device 73 is a device that receives a wireless signal arriving at the host vehicle 100 from the outside of the host vehicle 100. In the present embodiment, the radio signal includes at least a signal representing information about the own-vehicle traveling-road RDego. The communication device 73 is electrically connected to ECU 90. The vehicle control device 10 acquires a wireless signal from the outside of the host vehicle 100 via the communication device 73, and acquires information on the host vehicle traveling road RDego as the road information IR based on the acquired wireless signal.

### Operation of the Vehicle Control Device

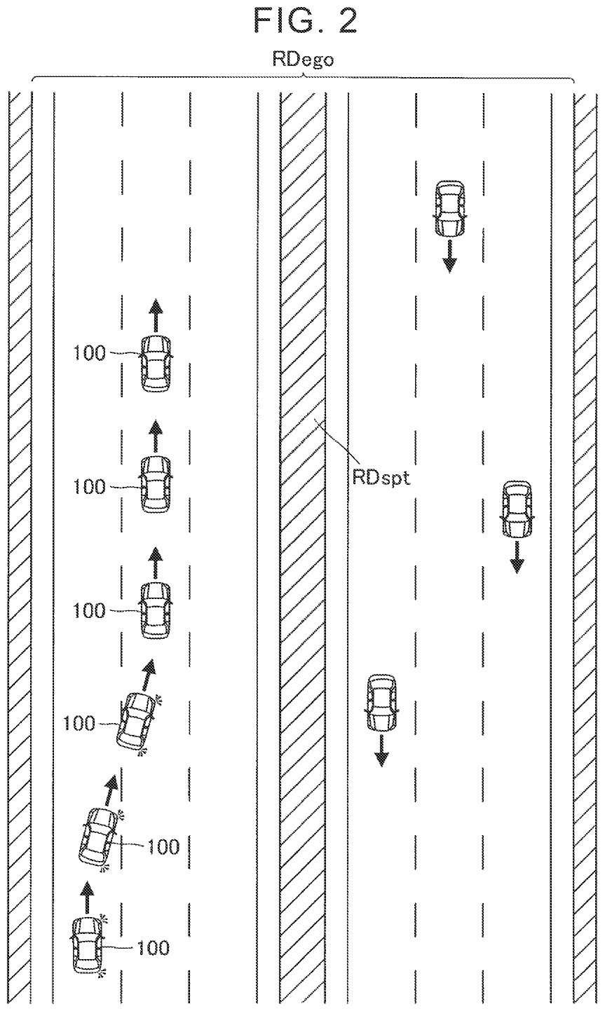

Next, the operation of the vehicle control device 10 will be described. The vehicle control device 10 is configured to execute lane change assist control for assisting lane change of the vehicle 100 as one of the automatic driving controls. In the present example, as illustrated in FIG. 2, the lane change assist control is a control in which the vehicle control device 10 autonomously steers the vehicle 100 and moves the vehicle 100 to an adjacent lane without requiring a driving operation by the driver of the vehicle 100. However, the lane change assist control may be a control for assisting a driving operation performed by a driver of the host vehicle 100 in order to move the host vehicle 100 to an adjacent lane.

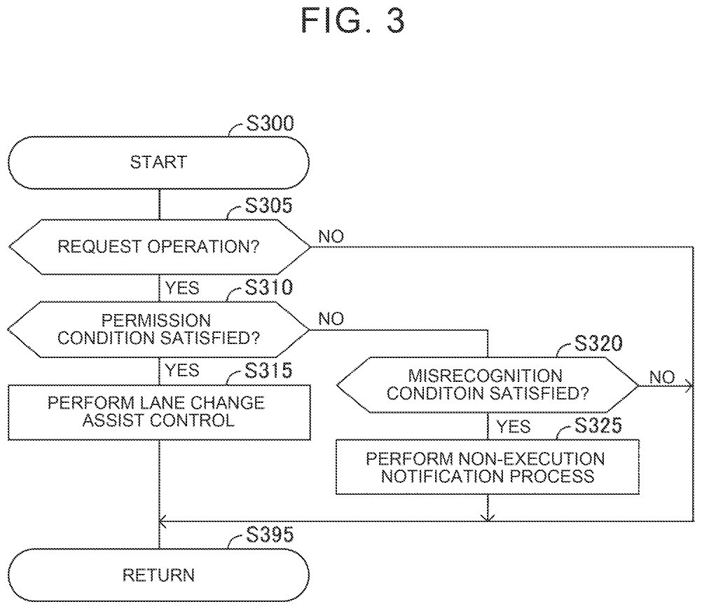

The vehicle control device 10 executes the routine illustrated in FIG. 3 at a predetermined calculation cycle to execute lane change assist control when a predetermined condition is satisfied.

Therefore, when the predetermined timing is reached, the vehicle control device 10 starts the processing from S300 of the routine shown in FIG. 3, advances the processing to S305, and determines whether or not the requesting operation has been performed.

The request operation is an operation for requesting the start of the lane change assist control. In the present example, the request operation is an operation of the winker lever 53 when the support precondition is satisfied, but may be an operation of another switch, a button, or the like when the support precondition is satisfied. Further, in the present example, the support precondition is a condition that the lane keeping control is executed, but the support precondition may not be provided. Note that the lane keeping control is control for autonomously controlling the steering force applied to the host vehicle 100 so that the host vehicle 100 travels in the center of the lane.

When “Yes” in S305, the vehicle control device 10 advances the process to S310 and determines whether or not the permission condition is satisfied.

The permission condition is a condition that the host vehicle traveling road RDego is a road on which the lane change of the host vehicle 100 using the lane change assist control is permitted. In this example, the permission condition includes first to third permission conditions, and is satisfied when all of the first to third permission conditions are satisfied.

The first permission condition is a condition that the own-vehicle traveling road RDego is a road on which walking of a person is prohibited. The second permission condition is a condition that a plurality of lanes having the same traveling direction are provided on the vehicle traveling road RDego. The third permission condition is a condition that the center separation zone RDspt (see FIG. 2) is provided on the own-vehicle traveling roadway RDego. The vehicle control device 10 determines whether the first to third permission conditions are satisfied based on the road information IR and/or the surroundings detection information IS.

When S310 determines “Yes”, the vehicle control device 10 advances the process to S315 and executes lane change assist control. After that, the vehicle control device 10 advances the processing to S395, and ends the processing of the routine once.

On the other hand, when “No” in S310, the vehicle control device 10 advances the process to S320 and determines whether the misrecognition condition is satisfied.

The misrecognition condition is a condition that the driver of the vehicle 100 misrecognizes the vehicle traveling road RDego as a road where the lane change of the vehicle 100 using the lane change assist control is permitted. In other words, the misrecognition condition is a condition that, among the features related to the road satisfying the permission condition, a feature other than the feature satisfying the permission condition that is easily recognized by the driver exists in relation to the own-vehicle traveling road RDego. In the present example, the error condition includes the first to fifth misrecognition conditions, and is satisfied when at least one of the first to fifth misrecognition conditions is satisfied.

The first misrecognition condition is a condition that the vehicle 100 is traveling on a national road, a local road, or the like and on a main road or a trunk road. The vehicle control device 10 determines whether or not the first misrecognition condition is satisfied based on the road information IR and/or the surroundings detection information IS.

The second misrecognition condition is a condition that the driver is highly likely to misrecognizes that the permission condition is satisfied, and that the driver is present on the road RDego of the vehicle. In other words, the second misrecognition condition is a condition that the same type of equipment is provided on the road where the permission condition is satisfied and that the same type of equipment as the equipment that does not satisfy the permission condition is provided on the road RDego of the vehicle. In the present example, the features of the second misrecognition condition include, for example, the presence of an entrance tollgate of an expressway, the presence of a waiting place, the presence of a central separation zone, the presence of a plurality of lanes having the same traveling direction, and the presence of a signboard or a sign indicating that pedestrian traffic is prohibited. The vehicle control device 10 determines whether or not the second misrecognition condition is satisfied based on the road information IR and/or the surroundings detection information IS.

The third misrecognition condition is a condition that a characteristic that is highly likely to cause the driver to misrecognize that the permission condition is satisfied exists in the traveling state of the vehicle 100. In the present example, the feature of the third misrecognition condition is, for example, that the distance traveled by the vehicle 100 without passing through the traffic light or the intersection is equal to or greater than a predetermined distance threshold. The vehicle control device 10 determines whether or not the third misrecognition condition is satisfied based on the road information IR and/or the surroundings detection information IS.

The fourth misrecognition condition is a condition that the vehicle 100 is traveling on the permission misrecognition road. The permission misrecognition road is a road that does not satisfy the permission condition, and is a road that is misrecognized as a road that satisfies the permission condition by a driver of another vehicle other than the vehicle 100. In other words, the permission misrecognition road is a road on which a driver of another vehicle different from the vehicle 100 misrecognizes the road as a road where the permission condition is satisfied.

Whether the fourth misrecognition condition is satisfied is determined, for example, by using so-called big data acquired as road-information IR. In this case, the vehicle control device 10 recognizes, based on the big data, a road on which the driver of the other vehicle other than the host vehicle 100 has operated the winker lever and has not changed the lane by operating the steering wheel itself for a predetermined time or longer, as a permission misrecognition road. Alternatively, the vehicle control device 10 recognizes, based on the big data, a road on which the driver of the other vehicle other than the host vehicle 100 has operated the winker lever for a predetermined period of time or more and in which the lane change has not been performed by operating the steering wheel himself/herself for a predetermined number of times or more, as a permission misrecognition road. In addition, the vehicle control device 10 may be configured to recognize the permission misrecognition road by using an AI technique such as so-called machine learning or deep learning when the permission misrecognition road is recognized based on the big data. Note that the vehicle control device 10 may be configured to receive the information on the permission misrecognition road by the communication device 73, and determine whether the vehicle traveling road RDego is the permission misrecognition road based on the information.

The fifth misrecognition condition is a condition that the vehicle speed V is equal to or higher than the predetermined speed threshold Vth.

When S320 determines “Yes”, the vehicle control device 10 advances the process to S325 and executes the non-execution notification process. After that, the vehicle control device 10 advances the processing to S395, and ends the processing of the routine once.

The non-execution notification process is a process of notifying the driver of the host vehicle 100 of information about not executing the lane change assist control. In the present example, the non-execution notification process is at least one of a process of displaying an image indicating that the lane change assist control is not executed on the display 41, a process of outputting a sound indicating that the lane change assist control is not executed from the speaker 42, and a process of vibrating the vibrator 43. In this example, the non-execution notification process may be a process of turning on a lamp or the like instead of or in addition to displaying an image indicating that the lane change assist control is not to be executed on the display 41.

Therefore, in a case where the request operation is performed by the driver of the vehicle 100 even though the permission condition is not satisfied, when the misrecognition condition is satisfied, the lane change assist control is not executed and the non-execution notification is given.

On the other hand, when S320 determines “No”, the vehicle control device 10 directly advances the processing to S395, and ends the processing of this routine once.

Therefore, in a case where the request operation is performed by the driver of the vehicle 100 even though the permission condition is not satisfied, when the misrecognition condition is not satisfied, the lane change assist control is not executed and the non-execution notification is not performed.

When S305 determines “No”, the vehicle control device 10 directly advances the processing to S395 and ends the processing of this routine once.

According to the vehicle control device 10, when the driver of the host vehicle 100 does not erroneously recognize that the lane change of the host vehicle 100 using the lane change assist control can be performed, the non-execution notification is not performed, and only when the driver of the host vehicle 100 erroneously recognizes that the lane change of the host vehicle 100 can be performed, the non-execution notification is given. Therefore, it is possible to reduce the possibility of the driver of the vehicle 100 being annoyed by the non-execution notification being given in a situation where the non-execution notification is unnecessary.

The present disclosure is not limited to the above embodiment, and various modifications can be adopted within the scope of the present disclosure.

What is claimed is:

1. A vehicle control device that executes a lane change assist control for assisting in lane change of a vehicle,
the vehicle control device being configured to execute the lane change assist control when a permission condition is satisfied at a time a request operation requesting to start the lane change assist control is performed by an operator of the vehicle, the permission condition being a condition that a road on which the vehicle is traveling is a road where the lane change of the vehicle using the lane change assist control is permitted, and not execute the lane change assist control when the permission condition is not satisfied at the time the request operation is performed by the operator, and
the vehicle control device being configured to give a non-execution notification when a misrecognition condition is satisfied in a case where the request operation is performed by the operator although the permission condition is not satisfied, the misrecognition condition being a condition that the operator misrecognizes the road on which the vehicle is traveling as the road where the lane change of the vehicle using the lane change assist control is permitted, and the non-execution notification being a notification for notifying the operator of information about not executing the lane change assist control, and not give the non-execution notification when the misrecognition condition is not satisfied in the case where the request operation is performed by the operator although the permission condition is not satisfied.

2. The vehicle control device according to claim 1, wherein the vehicle control device is configured to determine that the misrecognition condition is satisfied when the vehicle is traveling on a trunk road.

3. The vehicle control device according to claim 1, wherein the vehicle control device is configured to determine that the misrecognition condition is satisfied when equipment of a same type as equipment that is mounted on a road where the permission condition is satisfied and that does not satisfy the permission condition is mounted on the road on which the vehicle is traveling.

4. The vehicle control device according to claim 1, wherein the vehicle control device is configured to determine that the misrecognition condition is satisfied when the vehicle is traveling on a road an operator of another vehicle different from the vehicle misrecognized as a road where a lane change of the another vehicle using the lane change assist control is permitted.

5. The vehicle control device according to claim 1, wherein the vehicle control device is configured to determine that the misrecognition condition is satisfied when a travel speed of the vehicle is equal to or higher than a predetermined speed threshold.
